(19) United States
(12) Patent Application Publication
(10) Pub. No.: US 2009/0104443 A1
(43) Pub. Date: Apr. 23, 2009

(54) FILM LAMINATE, PRODUCTION METHOD THEREOF, AND OPTICALLY-COMPENSATORY FILM, POLARIZING PLATE, POLARIZING PLATE PROTECTIVE FILM AND LIQUID CRYSTAL DISPLAY USING THE SAME

(75) Inventor: Masaya Suzuki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/294,216

(22) PCT Filed: Mar. 26, 2007
(86) PCT No.: PCT/JP2007/057322

§ 371 Date: Sep. 23, 2008

(30) Foreign Application Priority Data
Mar. 27, 2006 (JP) 2006-086303

(51) Int. Cl. B32B 27/36; B32B 5/16; B29C 39/14

(52) U.S. Cl. 428/339; 428/483; 428/327; 156/246; 156/229

(57) ABSTRACT

A film laminate comprises a cyclic polyolefin film containing a cyclic polyolefin-based resin; and a thermoplastic film containing a thermoplastic resin, wherein a static friction coefficient between one surface of the film laminate and the other surface of the film laminate is from 0.2 to 0.8.

### TECHNICAL FIELD

The present invention relates to a cyclic polyolefin film, a laminate thereof, a process for the production thereof, an optically-compensatory film, polarizing plate, a polarizing plate protective film and a liquid crystal display comprising a cyclic polyolefin film.

### BACKGROUND ART

A polarizing plate is typically produced by attaching a film mainly formed of cellulose triacetate as a protective film on both sides of a polarizer which is formed of iodine or a dichroic dye aligned and adsorbed to polyvinyl alcohol. Cellulose triacetate has features of being high in rigidity, flame resistance, and optical isotropy (low retardation value), and is widely used for the above-described polarizing plate protective film. A liquid-crystal display device is formed of a polarizing plate, a liquid-crystal cell, etc. Today, TN-mode TFT liquid-crystal display devices, which are the main stream of the liquid-crystal display devices, realize high display visibility by inserting an optically-compensatory film (including an optically-compensatory sheet or retardation film defined in JP-A-8-50206, etc.) between a polarizing plate and a liquid-crystal cell (the term “JP-A” as used herein means an “unexamined published Japanese patent application”) However, cellulose triacetate film is disadvantageous in that it has a high water absorption or permeation and thus is subject to change of optical compensation properties or deterioration of polarizer.

A cyclic polyolefin film has been noted as a film having improvements in hygroscopicity and moisture permeability of cellulose triacetate film. A technique for producing a polarizing plate protective film of cyclic polyolefin by heat fusion film forming and solution film forming has been developed. The cyclic polyolefin film has a high optical property developability and thus has been under development for retardation film (JP-A-2003-212927, JP-A-2004-126026, JP-A-2002-114827 and WO2004/049011). However, the elastic modulus of the cyclic polyolefin film is normally about 300 kgf/mm² or less, which is relatively lower than that of cellulose acetate film (about 400 kgf/mm²). Therefore, during film forming or lamination on polarizing plate or other parts, or even when shipped in a rolled form, the cyclic polyolefin film is subject to wrinkling or like defects due to frictional force developed between one surface of one sheet of cyclic polyolefin film and the other side of another sheet of cyclic polyolefin film. Further, the resulting possible stress causes the change of chemical properties and hence unevenness of optical properties. As a result, when the cyclic polyolefin film is used in liquid crystal display devices, image unevenness or other defects can occur. These defects have been problems to be solved.

### DISCLOSURE OF THE INVENTION

An aim of the invention is to provide a cyclic polyolefin film which exhibits excellent moisture absorption and moisture permeability, undergoes little change of optical properties with temperature and humidity and shows no optical unevenness and a process for the production thereof and more particularly to provide a cyclic polyolefin film which undergoes little wrinkling during film forming, processing or shipping and shows no change of optical properties due to stress.

Another aim of the invention is to provide a polarizing plate protective film and an optically-compensatory film comprising the cyclic polyolefin film and more particularly to provide a polarizing plate or liquid crystal display having no image unevenness.

The inventors made extensive studies of solution to the aforementioned problems. As a result, it was found that the use of a laminate comprising a film (cyclic polyolefin film) containing a cyclic polyolefin-based resin and a film containing a thermoplastic resin laminated on each other wherein the static friction coefficient of a surface of one sheet of the laminate with the other surface of another sheet of the film laminate is from not smaller than 0.2 to 0.8 makes it possible to enhance the handleability during film forming and remarkably eliminate the occurrence of wrinkles due to backlash during winding, resulting in the production of a cyclic polyolefin film having no optical unevenness. Further, the incorporation of fine particles having a primary average particle diameter of from 1 nm to 20,000 nm as a component of the cyclic polyolefin film in an amount of from 0.01 to 0.3 parts by mass based on 100 parts by mass of the cyclic polyolefin-based resin made it possible to solve the aforementioned problems more effectively.

The aforementioned problems can be solved by the following constitutions.

(1) A film laminate comprising:

a cyclic polyolefin film containing a cyclic polyolefin-based resin; and

a thermoplastic film containing a thermoplastic resin,

wherein a static friction coefficient between one surface of the film laminate and the other surface of the film laminate is from 0.2 to 0.8

(2) The film laminate as described in 1),

wherein the thermoplastic resin comprises a polyethylene terephthalate, polyethylene or polypropylene.

(3) The film laminate as described in (1),

wherein the cyclic polyolefin film has a thickness of from 10 μm to 120 μm.

(4) The film laminate as described in (1),

wherein the cyclic polyolefin film further contains fine particles having a primary average particle diameter of from 1 nm to 20,000 nm in an amount of from 0.01 to 0.3 parts by mass based on 100 parts by mass of the cyclic polyolefin-based resin.

(5) The film laminate as described in (4),

wherein the fine particles are fine particles of a metal oxide or fine particles of inorganic silicon compound, each of which have a primary average particle diameter of from 2 nm to 1,000 nm.

(6) A production method of the film laminate as described in any one of (1) to (5), which comprises:

a step of dissolving the cyclic polyolefin-based resin in a solvent so as to form a dope;

a step of casting the dope so as to form the cyclic polyolefin film;

a step of drying the cyclic polyolefin film; and

a step of sticking the cyclic polyolefin film to the thermoplastic film at any step after the step of casting.

(7) The production method of the film laminate as described in (6), which further comprises:

a step of stretching the cyclic polyolefin film after the step of casting.

(8) An optically-compensatory film comprising:

the film laminate as described in any one of (1) to (5); and

an optically anisotropic layer which is stuck to the film laminate and has Re₆₃₀ of from 0 nm to 200 nm and |Rth₆₃₀| of from 0 nm to 400 nm,

wherein Re₆₃₀ represents an in-plane retardation value of the optically anisotropic layer at a wavelength of 620 nm; and

Rth₆₃₀ represents a thickness-direction retardation value of the optically anisotropic layer at a wavelength of 620 nm.

(9) A polarizing plate comprising the film laminate as described in any one of (1) to (5) as a protective film for polarizing film.

(10) A liquid crystal display comprising the polarizing plate as described in (9).

### BEST MODE FOR CARRYING OUT THE INVENTION

The invention will be further described hereinafter.

### (Cyclic Polyolefin-Based Resin)

Examples of the polymer resin having a cyclic olefin structure (cyclic polyolefin-based resin) employable herein include (1) norbornene-based polymers, (2) monocyclic olefin polymers, (3) cyclic conjugated diene polymers, (4) vinyl-alicyclic hydrocarbon polymers, and hydride of polymers (1) to (4). Preferred examples of the polymer employable herein include addition (co)polymer cyclic polyolefins containing at least one of repeating units represented by the following formula (II), optionally containing at least one of repeating units represented by the formula (I). Alternatively, ring opening (co)polymers containing at least one cyclic repeating units represented by the formula (III) are preferably used.

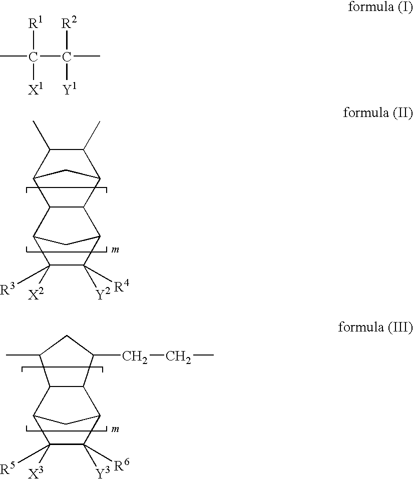

wherein m represents an integer of from 0 to 4; R¹ to R⁶ each represent a hydrogen atom or a C₁-C₁₀ hydrocarbon group; and X¹ to X³ and Y¹ to Y³ each represent a hydrogen atom, a C₁-C₁₀ hydrocarbon group, a halogen atom, a C₁-C₁₀ hydrocarbon group substituted by halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW or (—CO)₂O or (—CO)₂NR¹⁵ formed by X¹ and Y¹ or X² and Y² in which R¹¹, R¹², R¹³, R¹⁴ and R¹⁵ each represent a hydrogen atom or C₁-C₂₀ hydrocarbon group, Z represents a hydrocarbon group or a hydrocarbon group substituted by halogen, W represents SiR¹⁶ₚD₃₋ₚ (in which R¹⁶ represents a C₁-C₁₀ hydrocarbon group, D represents a halogen atom, —OCOR¹⁶ or —OR¹⁶, and p represents an integer of from 0 to 3), and n represents an integer of from 0 to 10.

The introduction of a functional group having a great polarity into the substituents X¹ to X³ and Y¹ to Y³ makes it possible to raise the thickness-direction retardation (Rth) of the optical film and hence the developability of in-plane retardation (Re). When the film having a great Re developability is stretched during film forming, Re value of the film can be raised.

Norbornene-based addition (co)polymers are disclosed in JP-A-10-7732, JP-T-2002-504184, US2004229157A1, WO2004/070463 μl, etc. These norbornene-based addition (co)polymers are obtained by addition polymerization of norbornene-based polycyclic unsaturated compounds. As necessary, a norbornene-based polycyclic unsaturated compound and a conjugated diene such as ethylene, propylene, butene, butadiene and isoprene, a nonconjugated diene such as ethylidene norbornene or a linear diene compound such as acrylonitrile, acrylic acid, methacrylic acid, maleic anhydride, acrylic acid ester, methacrylic acid ester, maleimide, vinyl acetate and vinyl chloride may be addition-polymerized with each other. This norbornene-based addition (co)polymer is commercially available from Mitsubishi Chemical Corporation in the trade name of “Apel”. Grades of Apel include those having different glass transition temperatures (Tg), e.g., APL8008T (Tg: 70° C.), APL6013T (Tg: 125° C.), APL6015T (Tg: 145° C.). Further, pelletized norbornene-based addition (co)polymers are commercially available from Polyplastics Co., Ltd. in the trade name of TOPAS8007, TOPAS6013, TOPAS6015, etc. Further, Appear 3000 is commercially available from Ferrania Inc.

Hydrides of norbornene-based polymer are prepared by subjecting a polycyclic unsaturated compound to addition polymerization or metathesis ring opening polymerization followed by hydrogenation as disclosed in JP-A-1-240517, JP-A-7-196736, JP-A-60-26024, JP-A-62-19801, JP-A-2003-159767, JP-A-2004-309979, etc. In the norbornene-based polymer to be used in the invention, R⁵ to R⁶ each preferably represent a hydrogen atom or —CH₃, X³ and Y³ each preferably represent a hydrogen atom, Cl or —COOCH₃, and the other groups are properly predetermined. This norbornene-based resin is commercially available from JSR Corporation in the trade name of “Arton G” or “Arton F”. This norbornene-based resin is commercially available also from ZEON CORPORATION in the trade name of “Zeonor ZF14 or ZF16” or “Zeonex 250 or 280”. These products may be used in the invention.

### (Fine Particles)

In accordance with the invention, the incorporation of fine particles in the aforementioned cyclic polyolefin-based resin makes it possible to further enhance the film-forming stability and processability of the film and eliminate the optical unevenness of the film attributed to backlash during winding. This is presumably because the incorporation of the fine particles causes the drop of the dynamic friction coefficient of the surface of the film resulting in the reduction of stress applied to the film during handling. As the fine particles to be used herein there may be used fine particles of organic or inorganic compound.

Preferred examples of the inorganic compound employable herein include silicon-containing compounds, silicon dioxide, titanium oxide, zinc oxide, aluminum oxide, barium oxide, zirconium oxide, strontium oxide, antimony oxide, tin oxide, antimony tin oxide, calcium carbonate, talc, clay, calcined kaolin, calcined calcium silicate, hydrous calcium silicate, aluminum silicate, magnesium silicate, and calcium phosphate. More desirable among these inorganic compounds are inorganic compounds containing silicon and metal oxides. Silicon dioxide is particularly preferably used because it can eliminate the turbidity of the film. As the fine particles of silicon dioxide there may be used a commercially available product, e.g., Aerosil R972, R974, R812, R200, R300, R202, OX50, TT600 (produced by NIPPON AEROSIL CO., LTD.). As the fine particles of zirconium oxide there may be used a commercially available product, e.g., Aerosil R976, R811 (produced by NIPPON AEROSIL CO., LTD.).

Examples of the organic compound employable herein include polytetrafluoroethylene, cellulose acetate, polystyrene, polymethyl methacrylate, polypropyl methacrylate, polymethyl acrylate, polyethylene carbonate, and starch. These organic compounds may be ground and classified before use. Further, polymer compounds synthesized by suspension polymerization method or spherulite polymer compounds obtained by spray dry method or dispersion method may be used.

The primary average particle diameter of these fine particles is preferably from 1 nm to 20,000 nm, more preferably from 1 nm to 10,000 nm, even more preferably from 2 nm to 1,000 nm, particularly preferably from 5 nm to 500 nm from the standpoint of suppression of haze. For the measurement of the primary average particle diameter of the fine particles, the average particle diameter of the particles may be determined under transmission type electron microscope. Most of commercially available fine particles are provided in aggregated form and thus are preferably dispersed by any known method before use. Dispersion is preferably effected so that the secondary particle diameter of the fine particles reaches a range of from 200 nm to 1,500 nm, more preferably from 300 nm to 1,000 nm. The amount of the fine particles to be incorporated is preferably from 0.01 to 0.3 parts by mass, more preferably from 0.05 to 0.2 parts by mass, most preferably from 0.08 to 0.12 parts by mass based on 100 parts by mass of the cyclic polyolefin-based resin.

The range of haze of the cyclic polyolefin-based resin thus having fine particles incorporated therein is preferably 2.0% or less, more preferably 1.2% or less, particularly preferably 0.5% or less. The dynamic friction coefficient of the cyclic polyolefin-based resin thus having fine particles incorporated therein is preferably 0.8 or less, particularly preferably 0.5 or less. The measurement of dynamic friction coefficient of the cyclic polyolefin-based resin can be carried out using a steel ball according to a method defined in JIS or ASTM. For the measurement of haze, a Type 1001DP haze meter (produced by NIPPON DENSHOKU CO., LTD.) may be employed.

### (Solvent)

The solvent for dissolving the cyclic polyolefin of the invention therein will be further described hereinafter. In the invention, the solvent employable herein is not specifically limited so far as the aim of the invention can be accomplished under the condition such that the cyclic polyolefin can be dissolved, casted and film-formed. As the solvent to be used in the invention there is preferably used one selected from the group consisting of chlorine-based solvents such as dichloromethane and chloroform, and C₃-C₁₂ chainlike hydrocarbons, cyclic hydrocarbons, aromatic hydrocarbons, esters, ketones and ethers. These esters, ketones and ethers may have a cyclic structure. Examples of the C₃-C₁₂ chainlike hydrocarbons employable herein include hexane, octane, isooctane, and decane. Examples of the C₃-C₁₂ cyclic hydrocarbons employable herein include cyclopentane, cyclohexane, and derivatives thereof. Examples of the C₃-C₁₂ aromatic hydrocarbons include benzene, toluene, and xylene. Examples of the C₃-C₁₂ esters employable herein include ethyl formate, propyl formate, pentyl formate, methyl acetate, ethyl acetate, and pentyl acetate. Examples of the C₃-C₁₂ ketones employable herein include acetone, methyl ethyl ketone, diethyl ketone, diisobutyl ketone, cyclopentanone, cyclohexanone, and methyl cyclohexanone. Examples of the C₃-C₁₂ ethers employable herein include diisopropylether, dimethoxymethane, dimethoxyethane, 1,4-dioxane, 1,3-dioxolane, tetrahydrofurane, anisole, and phenethol. Alternatively, an organic solvent having two or more functional groups may be used. Examples of such an organic solvent employable herein include 2-ethoxyethyl acetate, 2-methoxyethanol, and 2-butoxy ethanol. The boiling point of the organic solvent is preferably from not lower than 35° C. to not higher than 150° C. As the solvent to be used in the invention there may be used two or more solvents in admixture for the purpose of adjusting the solution physical properties such as dryability and viscosity. Further, a poor solvent may be added so far as the resulting mixture of solvents can dissolve the cyclic polyolefin therein.

The poor solvent which can be used in the invention can be properly selected depending on the kind of the polymer used. In the case where as a good solvent there is used a chlorine-based organic solvent, an alcohol may be used to advantage. The alcohol to be used herein may be preferably straight-chain, branched or cyclic. Preferred among these alcohols are saturated aliphatic hydrocarbons. The hydroxyl group in the alcohol may be any of primary to tertiary hydroxyl groups. Examples of the alcohol employable herein include methanol, ethanol, 1-propanol, 2-propanol, 1-butanol, 2-butanol, t-butanol, 1-pentanol, 2-methyl-2-butanol, and cyclohexanol. As the alcohol there may be used a fluorine-based alcohol. Examples of the fluorine-based alcohol employable herein include 2-fluoroethanol, 2,2,2-trifluoroethanol, and 2,2,3,3-tetrafluoro-1-propanol. Among these poor solvents, monovalent alcohols have an effect of eliminating peel resistance and thus can be used to advantage. The alcohols which are particularly preferably used depend on the kind of the good solvent selected. However, taking into account the drying load, an alcohol having a boiling point of 120° C. or less is preferably used. More preferably, a monovalent alcohol having from 1 to 6 carbon atoms is used. A C₁-C₄ monovalent alcohol is particularly preferably used. A solvent mixture which is particularly preferably used from the standpoint of the preparation of the cyclic polyolefin solution is a combination of dichloromethane as a main solvent and one or more alcohols selected from the group consisting of methanol, ethanol, propanol, isopropanol and butanol as a poor solvent.

### (Additive)

The cyclic polyolefin solution of the invention may comprise various additives (e.g., deterioration inhibitor, ultraviolet inhibitor, retardation (optical anisotropy) adjustor, peel accelerator, plasticizer, infrared absorber) incorporated therein at various preparation steps depending on the purpose. These additives may be in the form of solid or oily matter. In other words, these additives are not specifically limited in its melting point or boiling point. For example, ultraviolet absorbing materials or deterioration inhibitors having a melting point of not higher than 20° C. and not lower than 20° C. may be mixed. Further, infrared absorbers are disclosed in JP-A-2001-194522. These additives may be added at any of steps of preparing the cyclic polyolefin solution (dope). The last step in the process for the production of the dope may be followed by a step of adding these additives. The amount of these materials to be added is not specifically limited so far as their function can be developed. In the case where the cyclic polyolefin is formed by a number of layers, the kind and amount of additives to be incorporated in the various layers may vary.

### (Deterioration Inhibitor)

The cyclic polyolefin solution of the invention may comprise any known deterioration (oxidation) inhibitor such as phenol-based oxidation inhibitor and hydroquinone-based oxidation inhibitor, e.g., 2,6-di-t-butyl, 4-methylphenol, 4,4′-thiobis-(6-t-butyl-3-methylphenol), 1,1′-bis(4-hydroxyphenyl)cyclohexane, 2,2′-methylenebis(4-ethyl-6-t-butylphenol), 2,5-di-t-butylhydroquinone, pentaerystyryl-tetrakis[3-(3,5-di-t-butyl-4-hydroxyphenyl)propionate incorporated therein. Further, a phosphoric oxidation inhibitor such as tris(4-methoxy-3,5-diphenyl)phosphite, tris(nonyl phenyl)phosphite, tris(2,4-di-t-butylphenyl)phosphite, bis(2,6-di-t-butyl-4-methylphenyl)pentaerythritol diphosphite and bis(2,4-di-t-butyl phenyl)pentaerythritol diphosphite is preferably incorporated in the cyclic polyolefin solution of the invention. The amount of the oxidation inhibitor to be incorporated in the cyclic polyolefin solution of the invention is preferably from 0.05 to 5.0 parts by mass based on 100 parts by mass of the cyclic polyolefin.

### (Ultraviolet Absorber)

The cyclic polyolefin solution of the invention preferably comprises an ultraviolet absorber incorporated therein from the standpoint of prevention of deterioration of polarizing plate, liquid crystal, etc. As the ultraviolet absorber there is preferably used one having little absorption of visible light having a wavelength of 400 nm or more from the standpoint of excellence in absorptivity of ultraviolet rays having a wavelength of 370 nm or less and enhancement of liquid crystal display properties. Specific examples of the ultraviolet absorber which is preferably used in the invention include hindered phenol-based compounds, oxybenzophenone-based compounds, benzotriazole-based compounds, salicylic acid ester-based compounds, benzophenone-based compounds, cyanoacrylate-based compounds, and nickel complex salt-based compounds. Examples of the hindered phenol-based compounds employable herein include 2,6-di-tert-butyl-p-cresol, pentaerythrithyl-tetrakis[3-(3,5-di-tert-butyl-4-hdyroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxy benzyl)benzene, and tris-(3,5-di-tert-butyl-4-hydroxy benzyl)-isocyanurate. Examples of the benzotriazole-based compounds employable herein include 2-(2′-hydroxy-5′-methylphenyl)benzotriazole, 2,2-methylenebis(4-(1,1,3,3-tetramethylbutyl)-6-(2H-benzotriazole-2-il)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′,5′-di-tert-butylphenyl)-5-chloro benzotriazole, (2(2′-hydroxy-3′,5′-di-tert-amyl phenyl)-5-chlorobenzotriazole, 2,6-di-tert-butyl-p-cresol, and pentaerythrithyl-tetrakis[3-(3,5-di-tert-butyl-4-hydroxyphenyl)propionate]. The amount of these ultraviolet absorbers to be incorporated in the cyclic polyolefin solution of the invention is preferably from 1 ppm to 1.0%, more preferably from 10 ppm to 1,000 ppm based on the mass of the cyclic polyolefin.

### (Retardation Developer)

In the invention, in order to develop the desired retardation value, a compound having at least two aromatic rings may be used as a retardation developer. The retardation developer, if any, is preferably used in an amount of from 0.05 to 20 parts by mass, more preferably from 0.1 to 10 parts by mass, even more preferably from 0.5 to 2 parts by mass based on 100 parts by mass of the polymer. Two or more retardation developers may be used in combination.

The retardation developer preferably exhibits a maximum absorption in a wavelength range of from 250 nm to 400 nm and substantially no absorption in the visible light range.

The term “aromatic ring” as used herein is meant to include aromatic heterocyclic groups in addition to aromatic hydrocarbon rings. The aromatic hydrocarbon ring is particularly preferably a 6-membered ring (i.e., benzene ring). The aromatic heterocyclic group is normally an unsaturated heterocyclic group. The aromatic heterocyclic group is preferably a 5-membered, 6-membered or 7-membered ring, more preferably a 5-membered ring or 6-membered ring. The aromatic heterocyclic group normally has the most numerous double bonds. The hetero atoms are preferably nitrogen atom, oxygen atom and sulfur atom, particularly preferably nitrogen atom. Examples of the aromatic heterocyclic group employable herein include furane rings, thiophene rings, pyrrole rings, oxazole rings, isooxazole rings, thiazole rings, isothiazole rings, imidazole rings, pyrazole rings, furazane rings, triazole rings, pyrane rings, pyridine rings, pyridazine rings, pyrimidine rings, pyrazine rings, and 1,3,5-triazine ring. Desirable among these the aromatic rings are benzene rings, furane rings, thiophene rings, pyrrole rings, oxazole rings, thiazole rings, imidazole rings, triazole rings, pyridine rings, pyrimidine rings, pyrazine rings, and 1,3,5-triazine ring. Particularly preferred among these aromatic rings is 1,3,5-triazine ring. In some detail, compounds disclosed in JP-A-2001-166144 are preferably used.

The number of aromatic rings to be contained in the retardation developer is preferably from 2 to 20, more preferably from 2 to 12, even more preferably from 2 to 8, most preferably from 2 to 6. Referring to the connection of two aromatic rings, (a) they may form a condensed ring, (b) they may be connected directly to each other by a single bond or (c) they may be connected to each other via a connecting group (No spiro bond cannot be formed due to aromatic ring). Any of the connections (a) to (c) may be established.

Preferred examples of the condensed ring (a) (formed by the condensation of two or more aromatic rings) include indene ring, naphthalene ring, azlene ring, fluorene ring, phenathrene ring, anthracene ring, acenaphthylene ring, biphenylene ring, naphthacene ring, pyrene ring, indole ring, isoindole ring, benzofurane ring, benzothiophene ring, indolizine ring, benzoxazole ring, benzothiazole ring, benzoimidazole ring, benzotriazole ring, purine ring, indazole ring, chromene ring, quinoline ring, isoquinoline ring, quinolidine ring, quinazoline ring, cinnoline ring, quinoxaline ring, phthaladine ring, puteridine ring, carbazole ring, acridine ring, phenathridine, xanthene ring, phenazine ring, phenothiazine ring, phenoxathine ring, phenoxazine ring, and thianthrene ring. Preferred among these condensed rings are naphthalene ring, azlene ring, indole ring, benzoxazole ring, benzothiazole ring, benzoimidazole ring, benzotriazole ring, and quinoline ring.

The single bond (b) is preferably a bond between the carbon atom of two aromatic rings. Two or more aromatic rings may be connected via two or more single bonds to form an aliphatic ring or nonaromatic heterocyclic group between the two aromatic rings.

The connecting group (c), too, is preferably connected to the carbon atom of two aromatic rings. The connecting group is preferably an alkylene group, alkenylene group, alkynylene group, —CO—, —O—, —NH—, —S— or combination thereof. Examples of the connecting group comprising these groups in combination will be given below. The order of the arrangement of components in the following connecting groups may be inverted.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and connecting group may have substituents. Examples of the substituents include halogen atoms (F, Cl, Br, I), hydroxyl groups, carboxyl groups, cyano groups, amino groups, nitro groups, sulfo groups, carbamoyl groups, sulfamoyl groups, ureido groups, alkyl groups, alkenyl groups, alkynyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, aliphatic substituted amino groups, aliphatic substituted carbamoyl groups, aliphatic substituted sulfamoyl groups, aliphatic substituted ureido groups, and nonaromatic heterocyclic groups.

The number of carbon atoms in the alkyl group is preferably from 1 to 8. A chain-like alkyl group is preferred to cyclic alkyl group. A straight-chain alkyl group is particularly preferred. The alkyl group preferably further has substituents (e.g., hydroxy group, carboxy group, alkoxy group, alkyl-substituted amino group) Examples of the alkyl group (including substituted alkyl group) include methyl group, ethyl group, n-butyl group, n-hexyl group, 2-hydroxyethyl group, 4-carboxybutyl group, 2-methoxyethyl group, and 2-diethylaminoethyl group.

The number of carbon atoms in the alkenyl group is preferably from 2 to 8. A chain-like alkynyl group is preferred to cyclic alkenyl group. A straight-chain alkenyl group is particularly preferred. The alkenyl group may further have substituents. Examples of the alkenyl group include vinyl group, allyl group, and 1-hexenyl group.

The number of carbon atoms in the alkynyl group is preferably from 2 to 8. A chain-like alkynyl group is preferred to cyclic alkynyl group. A straight-chain alkynyl group is particularly preferred. The alkynyl group may further have substituents. Examples of the alkynyl group include ethinyl group, 1-butinyl group, and 1-hexinyl group.

The number of carbon atoms in the aliphatic acyl group is preferably from 1 to 10. Examples of the aliphatic acyl group include acetyl group, propanoyl group, and butanoyl group.

The number of carbon atoms in the aliphatic acyloxy group is preferably from 1 to 10. Examples of the aliphatic acyloxy group include acetoxy group.

The number of carbon atoms in the alkoxy group is preferably from 1 to 8. The alkoxy group may further has substituents (e.g., alkoxy group). Examples of the alkoxy group (including substituted alkoxy groups) include methoxy group, ethoxy group, butoxy group, and methoxyethoxy group.

The number of carbon atoms in the alkoxycarbonyl group is preferably from 2 to 10. Examples of the alkoxycarbonyl group include methoxycarbonyl group, and ethoxycarbonyl group.

The number of carbon atoms in the alkoxycarbonylamino group is preferably from 2 to 10. Examples of the alkoxycarbonylamino group include methoxycarbonylamino group, and ethoxycarbonylamino group.

The number of carbon atoms in the alkylthio group is preferably from 1 to 12. Examples of the alkylthio group include methylthio group, ethylthio group, and octylthio group.

The number of carbon atoms in the alkylsulfonyl group is preferably from 1 to 8. Examples of the alkylsulfonyl group include methanesulfonyl group, and ethanesulfonyl group.

The number of carbon atoms in the aliphatic amide group is preferably from 1 to 10. Examples of the aliphatic amide group include acetamide group.

The number of carbon atoms in the aliphatic sulfonamide group is preferably from 1 to 8. Examples of the aliphatic sulfonamide group include methanesulfonamide group, butanesulfonamide group, and n-octanesulfonamide group.

The number of carbon atoms in the substituted aliphatic amino group is preferably from 1 to 10. Examples of the aliphatic substituted amino group include dimethylamino group, diethylamino group, and 2-carboxyethylamino group.

The number of carbon atoms in the substituted aliphatic carbamoyl group is preferably from 2 to 10. Examples of the aliphatic substituted carbamoyl group include methylcarbamoyl group, and diethylcarbamoyl group.

The number of carbon atoms in the substituted aliphatic sulfamoyl group is preferably from 1 to 8. Examples of the aliphatic substituted sulfamoyl group include methylsulfamoyl group, and diethylsulfamoyl group.

The number of carbon atoms in the substituted aliphatic ureido group is preferably from 2 to 10. Examples of the aliphatic substituted ureido group include methylureido group.

Examples of the nonaromatic heterocyclic group include piperidino group, and morpholino group. The molecular weight of the retardation developer made of discotic compound is preferably from 300 to 800.

In the invention, a rod-shaped compound having a linear molecular structure may be preferably used besides the compounds comprising 1,3,5-triazine ring. The term “linear molecular structure” as used herein is meant to indicate that the molecular structure of the rod-shaped compound which is most thermodynamically stable is linear. The most thermodynamically stable structure can be determined by crystallographic structure analysis or molecular orbital calculation. For example, a molecular orbital calculation software (e.g., WinMOPAC2000, produced by Fujitsu Co., Ltd.) may be used to effect molecular orbital calculation, making it possible to determine a molecular structure allowing the minimization of heat formation of compound. The term “linear molecular structure” as used herein also means that the most thermodynamically stable molecular structure thus calculated forms a main chain at an angle of 140 degrees or more.

As the rod-shaped compound having at least two aromatic rings there is preferably used a compound represented by the following formula (IV)

Ar¹-L¹-Ar² formula (IV)

In the formula (IV), Ar¹ and Ar² each independently represent an aromatic ring. Examples of the aromatic ring employable herein include aryl groups (aromatic hydrocarbon group), substituted aryl groups, aromatic heterocyclic groups, and substituted aromatic heterocyclic groups. The aryl group and substituted aryl group are preferred to the aromatic heterocyclic group and substituted aromatic heterocyclic group. The heterocyclic group in the aromatic heterocyclic group is normally unsaturated. The aromatic heterocyclic group is preferably a 5-membered ring, 6-membered ring or 7-membered ring, more preferably a 5-membered ring or 6-membered ring. The aromatic heterocyclic group normally has the most numerous double bonds. The hetero atom is preferably nitrogen atom, oxygen atom or sulfur atom, more preferably nitrogen atom or sulfur atom. Preferred examples of the aromatic ring in the aromatic group include benzene ring, furane ring, thiophene ring, pyrrole ring, oxazole ring, thiazole ring, imidazole ring, triazole ring, pyridine ring, pyrimidine ring, and pyrazine ring. Particularly preferred among these aromatic rings is benzene ring.

In the formula (IV), L¹ represents a divalent connecting group selected from the group consisting of groups composed of alkylene group, alkenylene group, alkynylene group, —O—, —CO— and combination thereof. The alkylene group may have a cyclic structure. The cyclic alkylene group is preferably cyclohexylene, particularly 1,4-cyclohexylene. As the chain-like alkylene group, a straight-chain alkylene is preferred to a branched alkylene. The number of carbon atoms in the alkylene group is preferably from 1 to 20, more preferably from 1 to 15, even more preferably from 1 to 10, even more preferably from 1 to 8, most preferably from 1 to 6.

The alkenylene group and alkynylene group preferably has a chain-like structure rather than cyclic structure, more preferably a straight-chain structure than branched chain-like structure. The number of carbon atoms in the alkenylene group and alkynylene group is preferably from 2 to 10, more preferably from 2 to 8, even more preferably from 2 to 6, even more preferably from 2 to 4, most preferably 2 (vinylene or ethinylene). The number of carbon atoms in the arylene group is preferably from 6 to 20, more preferably from 6 to 16, even more preferably from 6 to 12. In the molecular structure of the formula (IV), the angle formed by Ar¹ and Ar² with L¹ interposed therebetween is preferably 140 degrees or more.

The rod-shaped compound is more preferably a compound represented by the following formula (V).

Ar¹-L²-X-L³-Ar² formula (V)

wherein Ar¹ and Ar² each independently represent an aromatic group. The aromatic group is defined and exemplified as in Ar¹ and Ar² in the formula (IV).

In the formula (V), L² and L³ each independently represent a divalent connecting group selected from the group consisting of alkylene group, —O—, —CO— and combination thereof. The alkylene group preferably has a chain-like structure rather than cyclic structure and more preferably has a straight-chain structure rather than branched chain-like structure. The number of carbon atoms in the alkylene group is preferably from 1 to 10, more preferably from 1 to 8, even more preferably from 1 to 6, still more preferably from 1 to 4, most preferably from 1 or 2 (methylene or ethylene). L² and L³ each are particularly preferably —O—CO— or —CO—O—. In the formula (V), X represents 1,4-cyclohexylene, vinylene or ethynylene. Two or more rod-shaped compounds having a maximum absorption wavelength (λmax) of shorter than 250 nm in the ultraviolet absorption spectrum of solution may be used in combination. The amount of the retardation developer to be incorporated in the cyclic polyolefin solution of the invention is preferably from 0.1 to 30% by mass, more preferably from 0.5 to 20% by mass based on the mass of the cyclic polyolefin.

### (Peel Accelerator)

As additives for reducing the peel resistance of the cyclic polyolefin film there have been found many compounds having an effect of surface active agent. As preferred release agents there are effectively used phosphoric acid ester-based surface active agents, carboxylic acid or carboxylate-based surface active agents, sulfonic acid or sulfonate-based surface active agents or sulfuric acid ester-based surface active agents. Alternatively, fluorine-based surface active agents obtained by replacing some of the hydrogen atoms connected to the hydrocarbon chain in the aforementioned surface active agents by fluorine atom are useful. Release agents will be exemplified below.

RZ-1: C₈H₁₇O—P(═O)—(OH)₂

RZ-2: C₁₂H₂₅O—P(═O)—(OK)₂

RZ-3: C₁₂H₂₅OCH₂CH₂O—P(═O)—(OK)₂

RZ-4: C₁₅H₃₁ (OCH₂CH₂)₅O—P(═O)—(OK)₂

RZ-5: {C₁₂H₂₅O(CH₂CH₂O)₅}₂—P(═O)—OH

RZ-6: {C₁₈H₃₅(OCH₂CH₂)₈O}₂—P(═O)—ONH₄

RZ-7: (t-C₄H₉)₃—C₆H₁₂—OCH₂CH₂O—P(═O)—(OK)₂

RZ-8: (iso-C₉H₁₉—C₆H₄—O—(CH₂CH₂O)₅—P(═O)—(OK) (OH)

RZ-9: C₁₂H₂₅SO₃Na

RZ-10: C₁₂H₂₅SO₃Na

RZ-11: C₁₇H₃₃COOH

RZ-12: C₁₇H₃₃COOH.N(CH₂CH₂OH)₃

RZ-13: iso-C₈H₁₇—C₆H₄—O—(CH₂CH₂O)₃—(CH₂)₂SO₃Na

RZ-14: (iso-C₉H₁₉)₂—C₆H₃—O—(CH₂CH₂O)₃—(CH₂)₄SO₃Na

RZ-15: Sodium triisopropylnaphthalenesulfonate

RZ-16: Sodium tri-t-butylnaphthalenesulonate

RZ-17: C₁₇H₃₃CON(CH₃)CH₂CH₂SO₃Na

RZ-18: C₁₂H₂₅—C₆H₄SO₃.NH₄

The amount of the release agent to be incorporated is preferably from 0.05 to 5% by mass, more preferably from 0.1 to 2% by mass, most preferably from 0.1 to 0.5% by mass based on the mass of the cyclic polyolefin.

### (Plasticizer)

A cyclic polyolefin-based resin film is normally poorer in flexibility and thus more subject to cracking when given a stress or shearing stress than cellulose acetate film. When processed at an optical film, a cyclic polyolefin resin film is subject to cracking at the section, causing the generation of swarf that stains the optical film, resulting in optical defects. In order to solve these problems, a plasticizer may be incorporated in the cyclic polyolefin-based resin. Specific examples of the plasticizer employable herein include phthalic acid ester-based plasticizers, trimellitic acid ester-based plasticizers, aliphatic dibasic acid ester-based plasticizers, orthophosphoric acid ester-based plasticizers, acetic acid ester-based plasticizers, polyester epoxylated ester-based plasticizers, ricinoleic acid ester-based plasticizers, polyolefin-based plasticizers, and polyethylene glycol-based compounds.

The plasticizer to be used herein is preferably selected from the group consisting of compounds which stay liquid at ordinary temperature and pressure and have a boiling point of 200° C. or more. Specific compounds may be exemplified as follows.

Examples of aliphatic dibasic acid ester-based plasticizers include dioctyl adipate (230° C./760 mmHg), dibutyl adipate (145° C./4 mmHg), di-2-ethylhexyl adipate (335° C./760 mmHg), dibutyl diglycol adipate (230 to 240° C./2 mmHg), di-2-ethylhexyl azelate (220° C. to 245° C./4 mmHg), and di-2-ethylhexyl sebacate (377° C./760 mmHg). Examples of phthalic acid ester-based plasticizers include diethyl phthalate (298° C./760 mmHg), diheptyl phthalate (235° C. to 245° C./10 mmHg), di-n-octylphthalate (210° C./760 mmHg), and diisodecyl phthalate (420° C./760 mmHg). Examples of polyolefin-based plasticizers include paraffin waxes (average molecular weight: 330 to 600; melting point: 45° C. to 80° C.) such as normal paraffin, isoparaffin and cycloparaffin, liquid paraffins (JIS K2231ISOVG8, VG15, VG32, VG68, VG100), paraffin pellets (melting point: 56° C. to 58° C., 58° C. to 60° C., 60° C. to 62° C., etc.), chlorinated paraffin, low molecular polyethylene, low molecular polypropylene, low molecular polyisobutene, hydrogenated polybutadiene, hydrogenated polyisoprene, and squalane.

The amount of the plasticizer to be incorporated is from 0.5 to 40.0% by mass, preferably from 1.0 to 30.0% by mass, more preferably from 3.0 to 20.0% by mass based on the mass of the cyclic polyolefin-based resin. When the amount of the plasticizer to be incorporated falls below the above defined range, the resulting plasticizing effect is insufficient, making it impossible to enhance the processability of the film. On the other hand, when the amount of the plasticizer to be incorporated exceeds the above defined range, the plasticizer can be eluted and separated out after a long period of time, causing optical unevenness, stain on other parts, etc., to disadvantage.

### <Thermoplastic Film>

As the thermoplastic film to be used herein there may be used any known film. Specific examples of these films include polyethylenes, polypropylenes, polystyrenes, polyvinyl chlorides, polyvinyl alcohols, polyethylene terephthalates, polyethylene naphthalates, polyimides, polycarbonates, nylons, polysulfones, polyether sulfones, polyether ether ketones, polyetherimides, polyphenylene sulfides, polyalylates, polyester ethers, polyurethanes, and polyvinyl butyrals disclosed in Tomoyuki Minami and Atsushi Osakada, “Kogyoyo Purasuchikku Firumu (Industrial Plastic Films)”, CTI Kako Gijutusu Kenkyukai, 1991 and “Kogyoyo Firumu Shijo (Industrial Film Market)”, CMC, 1993. Preferred among these films are polyethylenes, polypropylenes, and polyethylene terephthalates from the standpoint of optical properties, physical properties and price of film. The thickness of the thermoplastic film is preferably from 10 μm to 100 μm, particularly preferably from 20 μm to 60 μm, even more preferably from 20 μm to 50 μm. During the production of the film, a lubricant such as the aforementioned fine particles, higher aliphatic acid and derivative thereof may be incorporated. Further, the functional layers such as stainproof layer, antistatic layer, slipping layer, adhesive layer and barrier layer or the side of the film opposite the cyclic polyolefin may be roughened by a method such as sand blasting, During this procedure, various surface treatments such as corona discharge and chemical treatment may be effected.

As the thermoplastic film of the invention there may be preferably used a commercially available protect film or release film as well. As such a film there may be used a protect film or release film commercially available from SUN A KAKEN CO., LTD., NITTO DENKO CORPORATION, Hitachi Chemical Co., Ltd., SEKISUI CHEMICAL CO., LTD., Teijin DuPont Films Japan Limited, FUJIMORI KOGYO CO., LTD., TORAY ADVANCED FILM CO, LTD., Lintec Corporation, Mitsubishi Chemical Polyester Film Co., Ltd., etc.

### <Measurement of Static Friction Coefficient>

For the measurement of static friction coefficient, a Type AMF RTA-100 Tensilon meter (produced by ORIENTEC Co., LTD) was used. The sample was then measured at 23° C.-65% RH. In some detail, a film cut into a size of 200 mm×100 mm was placed on a sample table with the measurement side thereof facing upward. A film cut into a size of 100 mm×75 mm was then superposed on the former film with the measurement side thereof facing downward. A weight of 200 g was then placed on the laminate. The weight was then pulled horizontally at a speed of 200 mm/min. The resulting peak test force was then determined. The value obtained by dividing the peak test force by the weight was defined to be static friction coefficient.

The static friction coefficient is preferably from 0.15 to 1.00, more preferably from 0.20 to 0.80. When the static friction coefficient is 0.15 or less, the slipperiness of the surfaces of the film is enhanced, causing the positional deviation of the film edge when the film is wound into a roll. Thus, the film cannot be normally wound. When the static friction coefficient is 1.00 or less, the handleability of the film during film-forming can be enhanced, making it successful to remarkably eliminate the generation of wrinkles due to backlash during winding. As a result, it was found that a cyclic polyolefin film having no optical unevenness can be obtained. Further, the incorporation of fine particles having a primary average particle diameter of from 1 nm to 20,000 nm in an amount of from 0.01 to 0.3 parts by mass based on 100 parts by mass of the cyclic polyolefin-based resin makes it possible to solve the aforementioned problems more effectively.

### [Process for the Production of Cyclic Polyolefin Film]

### [Dissolving Step]

In the method for the preparation of the solution (dope) of the cyclic polyolefin film of the invention, the dissolving method is not specifically limited. The dissolution of the raw materials may be effected at room temperature. Alternatively, the dissolution of the raw materials may be effected by either or both of a cold dissolving method or a hot dissolving method. For the preparation of the cyclic polyolefin solution of the invention, the solution concentration involved in the dissolving step and the filtration, the production process described in detail in Kokai Giho 2001-1745, Japan Institute of Invention and Innovation, pp. 22-25, Mar. 15, 2001, is preferably employed.

### (Transparency of Dope)

The transparency of the dope which is the cyclic polyolefin solution according to the invention is preferably 85% or more, more preferably 88% or more, even more preferably 90% or more. It was confirmed that the dope solution of the cyclic polyolefin of the invention has various additives sufficiently dissolved therein. Referring in detail to the method for calculating the dope transparency, a glass cell having a size of 1 cm square filled with the dope solution was measured for absorbance at 550 nm using a Type UV-3150 spectrophotometer (produced by Shimadzu Corporation). The solvent alone had been previously measured for absorbance as a blank. The transparency of the dope was then calculated from the ratio of absorbance of the dope solution to absorbance of the blank.

### [Casting Step, Drying Step, Winding Step]

A process for the production of a film from the cyclic polyolefin solution (dope) in the invention will be described hereinafter.

As the method and the device for producing the cyclic polyolefin film of the invention there may be used any solution casting/filming method and solution casting/filming device for use in the related art method of producing cellulose acetate film, respectively. The dope prepared in the dissolving machine (kiln) is stored in a storage kiln so that bubbles contained in the dope are removed to make final adjustment. The dope thus adjusted is then delivered from the dope discharge port to a pressure die through a pressure constant rate gear pump capable of delivering a liquid at a constant rate with a high precision depending on the rotary speed. The dope is then uniformly casted through the slit of the pressure die over a metallic support in the casting portion which is being running endlessly. When the metallic support has made substantially one turn, the half-dried dope film (also referred to as “web”) is then peeled off the metallic support.

During the peeling of the film from the support, the degree of drying and evaporation of solvent from the film (half-driedness) has an effect on the physical properties of the film. In some detail, the more half-dried the film is peeled from the support and the more rapidly the film thus peeled is dried, the more rapidly the crystallization of polymer chain in the film proceeds, making it possible to render the film relatively hard and further improve the physical properties such as dimensional change of the film. On the other hand, the more slowly is dried the film which has been already dried and then peeled off the support, the more slowly the crystallization of polymer chain in the film proceeds, making it possible to render the film relatively soft. In the invention, in order to obtain a film which has been crystallized so much that the X-ray diffraction pattern falls within the desired range, peeling is preferably effected while the residual solvent content falls within the range of from not smaller than 50% to not greater than 200%. The residual solvent content during peeling is preferably from not smaller than 55% to not greater than 180%, more preferably from not smaller than 60% to not greater than 150%. The residual solvent content is represented by the following numerical formula (9). The residual volatile content mass is the value obtained by subtracting the mass of the film from the mass of the film which has been subjected to heat treatment at 120° C. for 2 hours.

### Residual Solvent Content

=Residual volatile mass/Mass of film heat-treated×100 (%)

The web thus obtained is dried while being conveyed over a tenter with the both edges thereof clamped by a clip and its width kept constant. Subsequently, the film thus obtained is mechanically conveyed over a group of rolls in the drying machine to finish drying, and then wound into a roll to a predetermined length using a winding machine.

### [Laminating Step]

The lamination of the cyclic polyolefin film and the thermoplastic resin on each other may be effected at any step after the step of casting cyclic polyolefin film but is preferably effected shortly before winding. In order to effect lamination, the thermoplastic film having an adhesive layer provided thereon and the acylate film were pressed over rollers. Heating may be effected at the same time with lamination. Alternatively, methods such as dry lamination, solvent-free lamination and wet lamination disclosed in Tomoytuki Minami and Atsushi Osakada, “Kogyoyo Purasuchikku Firumu (Industrial Plastic Films)”, CTI Kako Gijutusu Kenkyukai, 1991 may be used.

### <Optical Properties of Cyclic Polyolefin Film>

In the invention, the terms “Re(λ)” and “Rth(λ)” as used herein are meant to indicate in-plane retardation and thickness direction retardation at a wavelength λ, respectively. Re(λ) is measured by the incidence of light having a wavelength λ nm in the direction normal to the film in “KOBRA 21ADH” or WR (produced by Ouji Scientific Instruments Co. Ltd.).

In the case where the film to be measured is represented by a monoaxial or biaxial refractive index ellipsoid, Rth(λ) is calculated by the following method.

Rth(λ) is calculated by “KOBRA 21ADH” or WR on the basis of retardation values Re (λ) measured on six points by the incidence of light having a wavelength λ nm in the direction inclined every 10° angle to 50° on one side thereof from the direction normal to the film with the in-plane slow axis (judged by “KOBRA 21ADH” or WR) as an inclined axis (rotary axis), hypothetical average refractive index and inputted film thickness.

In the foregoing calculation, in the case of a film having a direction in which the retardation value is zero at a certain angle of inclination with the in-plane slow axis normal to the film as a rotary axis, the retardation value at an angle of inclination greater than that angle of inclination is determined by converting its sign to negative before calculation by “KOBRA 21ADH” or WR.

Rth may be also determined by measuring the retardation value in two arbitrary oblique directions with the slow axis as an inclined axis (rotary axis) (in the case where there is no slow axis, an arbitrary axis in the plane of film is the rotary axis), and then subjecting the value thus obtained, hypothetical average refractive index and inputted film thickness to calculation according to the following numerical formulas (1) and (2).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos \{ {sin}^{- 1} ( \frac{sin ( - θ )}{nx} ) \}} \\ \begin{matrix}( Note ) \text{:} Re ( θ ) indicates the retardation value in the direction inclined \\ at an angle θ from the direction normal to the film .\end{matrix} \qquad numerical formula ( 1 )$$

In the numerical formula (1), nx represents the refractive index in in-plane slow axis direction, ny represents the refractive index in the direction normal to nx and nz represents the refractive index in the direction normal to nx and ny.

Rth=((nx+ny)/2×d numerical formula (2)

In the case where the film to be measured cannot be expressed by a monoaxial or biaxial refractive index ellipsoid, that is, the film to be measured has no so-called optical axis, Rth(λ) is calculated by the following method.

Rth(λ) is calculated by “KOBRA 21ADH” or WR on the basis of retardation values Re (λ) measured on 11 points by the incidence of light having a wavelength λ nm in the direction inclined every 10° angle to 50° from −50° to +50° from the direction normal to the film with the in-plane slow axis (judged by “KOBRA 21ADH” or WR) as an inclined axis (rotary axis), hypothetical average refractive index and inputted film thickness.

As the hypothetical average refractive index to be used in the foregoing measurement, there may be used one disclosed in “Polymer Handbook”, John Wiley & Sons, Inc. and various catalogues of optical films. For the optical films having an unknown average refractive index, an Abbe refractometer may be used. The average refractive index of main optical films are exemplified below. Cellulose acylate (1.48), cycloolefin polymer (1.52), polycarbonate (1.59), polymethylene methacrylate (1.49), polystyrene (1.59). By inputting the hypothetic average refractive indexes and film thicknesses, “KOBRA 21ADH” or WR calculates nₓ, n_{y} and n_{z}. From nₓ, n_{y} and n_{z}, is then calculated N_{z}=(nₓ−n_{z})/(nₓ−n_{y}).

### <Purpose of Cyclic Polyolefin Film>

### [Optically-Compensatory Film]

The cyclic polyolefin film of the invention may be used for various purposes and can be used particularly for optically-compensatory film for liquid crystal display to advantage. The term “optically-compensatory film” as used herein is meant to indicate an optical material which is normally used for liquid crystal display to compensate retardation and is used synonymously with retardation plate, optically-compensatory sheet or the like. An optically-compensatory film is birefringent and is used for the purpose of removing color from the display panel of liquid crystal device or improving viewing angle properties.

The optical anisotropy of the cyclic polyolefin film of the invention can be adjusted in accordance with the purpose of the film by stretching it after casting. The film is preferably stretched by a factor of 2 to 150%. When the residual solvent is remained in the film, the film can be stretched at lower temperature than a dried film. Many of the cyclic polyolefin films have high glass transition temperatures (Tg), but they can be stretched at lower temperatures than their intrinsic Tgs. The stretching of the film may be longitudinal or crosswise monoaxial stretching, or simultaneous or sequential biaxial stretching. When the film is stretched, the film has preferably the residual solvent content of 5 to 250% and more preferably 10 to 120%. When the film has the residual solvent content of 250% or less, the film has self-supportability and therefore is easily stretched. When the film has the residual solvent content of 5% or more, the film is not so dried and therefore is easily stretched.

In the case where the cyclic polyolefin film of the invention is used for the optically-compensatory film of liquid crystal display device, the optically anisotropic layer can be used in combination therewith. Re₆₃₀ and |Rth₆₃₀| of the optically anisotropic layer are preferably from 0 nm to 200 nm and from 0 nm to 400 nm, respectively. Any optically anisotropic layer may be used so far as Re and Rth fall within the above defined range.

The optical properties or driving system of the liquid crystal cell of the liquid crystal display comprising the cyclic polyolefin film of the invention is not specifically limited. The cyclic polyolefin film of the invention may be combined with any optically anisotropic layer required as optically compensatory film. The optically anisotropic layer which can be combined with the cyclic polyolefin film of the invention may be formed by a composition containing a liquid crystal compound or a birefringent polymer film. These optically anisotropic layers may be used in combination.

### [Optically Anisotropic Layer Containing Liquid Crystal Compound]

In the case where as the optically anisotropic layer there is used an optically anisotropic layer containing a liquid crystal compound, a discotic liquid crystal compound or rod-shaped liquid crystal compound is preferably used.

### [Discotic Liquid Crystal Compound]

Examples of the discotic liquid crystal compound which can be used in the invention include compounds disclosed in various references (C. Destrade et al., “Mol. Crysr. Liq. Cryst.”, vol. 71, page 111, 1981; “Quarterly Review of Chemistry”, The Chemical Society of Japan, No. 22, “Ekisho no Kagaku (Chemistry of Liquid Crystals)”, Chapter 5, Section 2 of Chapter 10, 1994; B. Kohne et al., “Angew. Chem. Soc. Chem. Comm.”, page 1,794, 1985; J. Zhang et al., “J. Am. Chem. Soc.”, vol. 116, page 2,655, 1994).

The optically anisotropic layer preferably has discotic liquid crystal molecules fixed aligned therein. Most preferably, these discotic liquid crystal molecules have been fixed by polymerization reaction. For the polymerization of discotic liquid crystal molecules, reference can be made to JP-A-8-27284. In order to fix discotic liquid crystal molecules by polymerization, it is necessary that a polymerizable group be connected as a substituent to the disc-shaped core of the discotic liquid crystal molecules. However, when a polymerizable group is connected directly to the disc-shaped core of the discotic liquid crystal molecules, the discotic liquid crystal molecules can be difficultly kept aligned in the polymerization reaction. In order to avoid this trouble, a connecting group is incorporated in between the disc-shaped core and the polymerizable group. For the details of discotic liquid crystal molecules having a polymerizable group, reference can be made to JP-A-2001-4387.

### (Rod-Shaped Liquid Crystal Compound)

Examples of the rod-shaped liquid crystal compound employable herein include azomethines, azoxys, cyanobiphenyls, cyanophenylesters, benzoic acid esters, cyclohexanecarboxylic acid phenyl esters, cyanophenyl cyclophexanes, cyano-substituted phenylpyrimdines, alkoxy-substituted phenylpyrimidines, phenyldioxanes, tolans, and alkenyl cyclohexylbenzonitriles. Not only the aforementioned low molecular liquid crystal compounds but also polymer liquid crystal compounds can be used.

The optically anisotropic layer preferably has rod-shaped liquid crystal molecules fixed aligned therein. Most preferably, these rod-shaped liquid crystal molecules have been fixed by polymerization reaction. Examples of the polymerizable rod-shaped liquid crystal compounds employable herein include compounds disclosed in “Makromol. Chem.”, vol. 190, page 2,255, 1989, “Advanced Materials”, vol. 5, page 107, 1993, U.S. Pat. Nos. 4,683,327, 5,622,648 and 5,770,107, WO95/22586, WO95/24455, WO97/00600, WO98/2358, WO98/52905, JP-A-1-272551, JP-A-6-16616, JP-A-7-110469, JP-A-11-80081, and JP-A-2001-328973.

### [Optically Anisotropic Layer Made of Polymer Film]

As mentioned above, the optically anisotropic layer according to the invention may be formed by a polymer film. The polymer film is formed by a polymer capable of developing optical anisotropy. Examples of such a polymer include polyolefins (e.g., polyethylene, polypropylene, norbornene-based polymer), polycarbonates, polyalylates, polysulfones, polyvinyl alcohols, polymethacrylic acid esters, polyacrylic acid esters, and cellulose esters (e.g., cellulose triacetate, cellulose diacetate). A copolymer or mixture of these polymers may be used.

The optical anisotropy of the polymer film is preferably obtained by stretching. The stretching of the polymer film is preferably effected monoaxially or biaxially. In some detail, monoaxial longitudinal stretching utilizing the difference in circumferential speed between two or more rolls or tenter stretching involving crosswise stretching with the both sides of the polymer film gripped by the tenter is preferably employed. Alternatively, biaxial stretching involving the two stretching methods in combination is preferably employed. Two or more sheets of polymer film may be used so far as the entire optical properties thereof satisfy the aforementioned requirements. The polymer film is preferably produced by solvent casting method to eliminate unevenness in birefringence. The thickness of the polymer film is preferably from 20 μm to 500 μm, most preferably from 40 μm to 100 μm.

There is preferably used also a method which comprises dissolving at least one polymer material selected from the group consisting of polyamide, polyimide, polyester, polyether ketone, polyamide imide, polyesterimide and polyaryl ether ketone as the polymer film forming the optically anisotropic layer in a solvent, spreading the solution thus obtained over a substrate, and then drying the coat layer to form a film. The polymer film and the substrate may be stretched to develop optical anisotropy. The film thus stretched can thus be used as an optically anisotropic layer. The cyclic polyolefin film of the invention can be preferably used as the aforementioned substrate. Alternatively, the aforementioned polymer film may be prepared on a substrate different from the cyclic polyolefin film of the invention, peeled off the substrate, and then stuck to the cyclic polyolefin film of the invention to form an optically anisotropic layer. This method makes it possible to reduce the polymer film. In this case, the thickness of the polymer film is preferably 50 μm or less, more preferably from 1 μm to 20 μm.

### [Polarizing Plate]

The use of the cyclic polyolefin film of the invention in a polarizing plate will be described hereinafter.

The cyclic polyolefin film of the invention is useful particularly as a protective film for polarizing plate. In the case where the cyclic polyolefin film of the invention is used as a protective film for polarizing plate, the method for the preparation of the polarizing plate is not specifically limited. The polarizing plate can be prepared by any ordinary method. There may be used a method which comprises subjecting the cyclic polyolefin film thus obtained to alkaline treatment, and then sticking the cyclic polyolefin film to the both surfaces of a polarizer prepared by dipping and stretching a polyvinyl alcohol film in an iodine solution with an aqueous solution of a fully saponified polyvinyl alcohol. The alkaline treatment may be replaced by adhesion processing disclosed in JP-A-6-94915 and JP-A-6-118232.

Examples of the adhesive to be used to stick the polarizing film to the treated surface of the protective film include polyvinyl alcohol-based adhesives such a polyvinyl alcohol and polyvinyl butyral, and vinyl-based latexes such as butyl acrylate.

### (Evaluation of Adhesion Between Protective Film and Polarizing Film)

In order to laminate the processed surface of the protective film and the polarizing film on each other, a sufficient adhesion is required. For the evaluation of adhesion of the cyclic polyolefin film of the invention, the cyclic polyolefin film of the invention is laminated on the polarizing film. The laminate is then dried so sufficiently that the adhesive is cured. The protective film is then peeled off the polarizing film. This procedure is then repeated 50 times. The evaluation of adhesion is made according to the following three stage criterion.

A: No exfoliation even after 50 repetitions of cycle
B: Exfoliation observed after from not smaller than 30 repetitions to less than 50 repetitions of cycle
C: Exfoliation observed after less than 30 repetitions of cycle

A polarizing plate comprises a polarizing film and a protective film provided on the both sides thereof. A protect film is stuck to one side of the polarizing plate and a separate film is stuck to the other side of the polarizing plate. The protective film and the separate film are used for the purpose of protecting the polarizing plate at the step of inspecting the product during the shipment of the polarizing plate. In this case, the protective film is stuck to the polarizing plate on the side thereof opposite the side at which the polarizing plate is stuck to the liquid crystal cell for the purpose of protecting the surface of the polarizing plate. The separate film is stuck to the polarizing plate on the side thereof at which the polarizing plate is stuck to the liquid crystal cell for the purpose of covering the adhesive layer stuck to the liquid crystal cell.

A liquid crystal display device normally comprises a substrate containing a liquid crystal disposed interposed between two sheets of polarizing plate. The polarizing plate protective film comprising a cyclic polyolefin film of the invention can provide excellent display properties even when disposed on any position. It is particularly preferred that the protective film be used in combination with the optically anisotropic layer to form an optically-compensatory film which is applied to the liquid crystal cell side. The polarizing plate protective film on the outermost surface of the display side of the liquid crystal display device has a transparent hard coat layer, an anti-glare layer, an antireflection layer or the like provided thereon. Therefore, the polarizing plate protective film is preferably used for this portion.

### [Liquid Crystal Display Device]

### [Configuration of Ordinary Liquid Crystal Display Device]

The use of the cyclic polyolefin film of the invention as a member of liquid crystal display device will be described hereinafter.

As previously mentioned, the cyclic polyolefin film of the invention is preferably used as a polarizing plate protective film. In the case where the polarizing plate thus obtained is used for liquid crystal display device, the liquid crystal display device comprises a liquid crystal cell having a liquid crystal supported between two sheets of electrode substrate and two sheets of polarizing plate disposed on the respective side thereof. Preferably, at least one sheet of optically-compensatory film is disposed interposed between the liquid crystal cell and the polarizing plate.

In the case where the cyclic polyolefin film is used as an optically-compensatory film, the transmission axis of the polarizing film and the slow axis of the optically-compensatory film made of cyclic polyolefin film may be disposed at any angle. The liquid crystal display device comprises a liquid crystal cell having a liquid crystal supported between two sheets of electrode substrate, two sheets of polarizing plate disposed on the respective side thereof and at least one sheet of optically-compensatory film disposed interposed between the liquid crystal cell and the polarizing film of the polarizing plate.

The liquid layer of the liquid cell is formed by encapsulating a liquid crystal in the space defined by interposing a spacer between two sheets of substrate. The transparent electrode layer is formed as a transparent film containing an electrically-conductive material on a substrate. The liquid crystal cell may further comprise a gas barrier layer, a hard coat layer or an undercoat layer (to be used to bond the transparent electrode layer) provided therein. These layers are normally provided on a substrate. The substrate of the liquid crystal cell normally has a thickness of from 50 μm to 2 mm.

### [Kind of Liquid Crystal Display Device]

The cyclic polyolefin film of the invention can be in liquid crystal cells of various display modes. Various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), ECB (electrically Controlled Birefringence) and HAN (Hybrid Aligned Nematic) have been proposed. Also, display modes developed by domain-division of the aforementioned display modes have been proposed. The cyclic polyolefin film of the invention is effective for any display modes of liquid crystal display devices. The cyclic polyolefin film of the invention is also effective for liquid crystal display devices of transmission type, reflection type or semi-transmission type liquid crystal display devices.

### (TN Mode Liquid Crystal Display Device)

The cyclic polyolefin film of the invention may be used also as a support of optically-compensatory film or polarizing plate protective film for TN type liquid crystal display devices having TN mode liquid crystal cell. Liquid crystal cells of TN mode and TN type liquid crystal display devices have long been known well. For the details of optically-compensatory film to be used in TN type liquid crystal display devices, reference can be made to JP-A-3-9325, JP-A-6-148429, JP-A-8-50206, and JP-A-9-26572. Reference can be further made to Mori et al, “Jpn. J. Appl. Phys.”, vol. 36 (1997), pp. 143 and 1,068.

### (STN Mode Liquid Crystal Display Device)

The cyclic polyolefin film of the invention may be used also as a support of optically-compensatory film or polarizing plate protective film for STN mode liquid crystal display devices having STN mode liquid crystal cell. In general, an STN mode liquid crystal display device has rod-shaped liquid crystal compound molecules disposed twisted at an angle of from 90° to 360° in the liquid crystal cell. The product (Δn-d) of the refractive anisotropy (Δn) of the rod-shaped liquid crystal compound and the cell gap (d) falls within the range of from 300 nm to 1,500 nm. For the optically-compensatory film to be used in STN mode liquid crystal display devices, reference can be made to JP-A-2000-105316.

### (VA Mode Liquid Crystal Display Device)

The cyclic polyolefin film of the invention is preferably used as a support of optically-compensatory film or polarizing plate protective film for VA mode liquid crystal display devices having VA mode liquid crystal cell. The retardation value Re and the retardation value Rth of the optically-compensatory film to be used in VA mode liquid crystal display devices are preferably from 0 nm to 150 nm and from 70 nm to 400 nm, respectively. The retardation value Re is more preferable from 20 nm to 70 nm. In the case where the VA mode liquid crystal display device has two sheets of optically anisotropic polymer films provided therein, these films each preferably have a retardation value Re of from 70 nm to 250 nm. In the case where the VA mode liquid crystal display device has one sheet of optically anisotropic polymer film provided therein, the film preferably has a retardation value Rth of from 150 nm to 400 nm. The VA mode liquid crystal display device may be of a domain-division type disclosed in JP-A-10-123576.

### (IPS Mode Liquid Crystal Display Device and ECB Mode Liquid Crystal Device)

The cyclic polyolefin film of the invention may be used as a support of optically-compensatory film or polarizing plate protective film for IPS mode liquid crystal display devices having IPS mode liquid crystal cell and ECB mode liquid crystal display devices having ECB mode liquid crystal cell. In these display modes, the liquid crystal material molecules are disposed substantially parallel to each other to make black display. When no voltage is applied, the liquid crystal molecules are disposed parallel to the surface of the substrate to make black display. In these embodiments, the polarizing plate comprising the cyclic polyolefin film of the invention contributes to the improvement of tint, the increase of viewing angle and the enhancement of contrast. In these embodiments, among the protective films in the upper and lower polarizing plates of the liquid crystal cell, the protective film disposed interposed between the liquid crystal cell and the polarizing plate (protective film on the cell side) preferably has a polarizing plate made of a cyclic polyolefin film having a small optical anisotropy provided on at least one side thereof. More preferably, provided interposed between the protective film of the polarizing plate and the liquid crystal cell is an optically anisotropic layer the retardation value of which is predetermined to be not greater than twice Δn-d of the liquid crystal layer.

### (OCB Mode Liquid Crystal Display Device and HAN Mode Liquid Crystal Display Device)

The cyclic polyolefin film of the invention may be used as a support of optically-compensatory film or polarizing plate protective film for OCB mode liquid crystal display devices having OCB mode liquid crystal cell and HAN mode liquid crystal display devices having HAN mode liquid crystal cell. Neither the in-plane direction nor the normal direction of the optically-compensatory film to be used in OCB mode liquid crystal display devices or HAN mode liquid crystal display devices preferably has direction in which the absolute value of retardation becomes minimum. The optical properties of the optically-compensatory film to be used in OCB mode liquid crystal display devices or HAN mode liquid crystal display devices, too, are determined by the optical properties of the optically anisotropic layer, the optical properties of the support and the disposition of the optically anisotropic layer with respect to the support. For the details of the optically-compensatory film to be used in OCB mode liquid crystal display devices or HAN mode liquid crystal display devices, reference can be made to JP-A-9-197397. Reference can be further made to Mori et al, “Jpn. J. Appl. Phys.”, vol. 38 (1999), pp. 2,837.

### (Reflection Mode Liquid Crystal Display Device)

The cyclic polyolefin film of the invention may be used as an optically-compensatory film or polarizing plate protective film for reflection type liquid crystal display devices of TN mode, STN mode or HAN mode GH (Guest-Host) mode to advantage. These display modes have long been known well. For the details of TN mode reflection type liquid crystal display devices, reference can be made to JP-A-10-123478, WO98/48320, and Japanese Patent No. 3,022,477. For the details of the optically-compensatory film to be used in the reflection type liquid crystal display devices, reference can be made to WO00/65384.

### (Other Liquid Crystal Display Devices)

The cyclic polyolefin film of the invention is used also as a support of optically-compensatory film or polarizing plate protective film for ASM type liquid crystal display devices having ASM (axially symmetric aligned microcell) mode liquid crystal cell to advantage. The ASM mode liquid crystal cell is characterized in that the thickness of the cell is kept by a positionally adjustable resin spacer. Other properties are the same as that of TN mode liquid crystal cell. For the details of ASM mode liquid crystal cells and ASM mode liquid crystal display devices, reference can be made to Kume et al, “SID 98 Digest 1089”, 1998.

### [Hard Coat Film, Anti-Glare Film, Antireflection Film]

The cyclic polyolefin film of the invention is preferably applied to hard coat film, anti-glare film and antireflection film. For the purpose of enhancing the viewability of the flat panel display such as LCD, PDP, CRT and EL, any or all of the hard coat layer, the anti-glare layer and the antireflection layer may be added to one or both sides of the cyclic polyolefin film of the invention. Preferred embodiments of such an anti-glare film and antireflection film are described in detail in Kokai Giho No. 2001-1745, Mar. 15, 2001, Japan Institute of Invention and Innovation, pp. 54-57. For these films, the cyclic polyolefin film of the invention is used to advantage. Further, any of the hard coat layer, anti-glare layer and antireflection layer may be added to the surface of the aforementioned polarizing plate to form a functional polarizing plate which can be used for liquid crystal display devices.

### [Transparent Substrate for Liquid Crystal Cell]

The cyclic polyolefin film of the invention exhibits substantially zero optical anisotropy and an excellent transparency and thus can be used as a substitute for liquid crystal cell glass substrate for liquid crystal display devices, i.e., transparent substrate in which a driving liquid crystal is encapsulated.

The transparent substrate in which a liquid crystal is encapsulated needs to be excellent in gas barrier properties. Therefore, a gas barrier layer may be provided on the surface of the cyclic polyolefin film of the invention as necessary. The form or material of the gas barrier layer is not specifically limited. However, there can be proposed a method which comprises vacuum-depositing SiO₂ or the like or providing a polymer coat layer having relatively high gas barrier properties such as vinylidene chloride-based polymer and vinyl alcohol-based polymer on at least one side of the cyclic polyolefin film of the invention. These methods can be properties used.

In order to use the cyclic polyolefin film of the invention as a transparent substrate in which a liquid crystal is encapsulated, a transparent electrode for driving the liquid crystal by a voltage applied may be provided. The transparent electrode to be used herein is not specifically limited but may be formed by laminating a metal film, metal oxide film or the like on at least one side of the cyclic polyolefin film of the invention. Preferred among these transparent electrode materials is metal oxide film from the standpoint of transparency, electrical conductivity and mechanical properties. In particular, a thin film of indium oxide mainly composed of tin oxide having zinc oxide incorporated therein in an amount of from 2% to 15% is preferably used. For the details of these techniques, reference can be made to JP-A-2001-125079, JP-A-2000-227603, etc.

### EMBODIMENT

The invention will be further described in the following examples, but the invention is not limited thereto.

### <Synthesis of Cyclic Polyolefin Polymer P-1>

100 parts by mass of a purified toluene and 100 parts by mass of a norbornenecarboxylic acid methyl ester were charged into a reaction vessel. Subsequently, into the reaction vessel were charged ethylhexanoate-Ni dissolved in toluene in an amount of 25 mmol-% (based on the mass of the monomer), tri(pentafluorophenyl)boron dissolved in toluene in an amount of 0.225 mol-% (based on the mass of the monomer) and triethyl aluminum dissolved in toluene in an amount of 0.25 mol-% (based on the mass of the monomer). The mixture was then reacted with stirring at room temperature for 18 hours. After the termination of the reaction, the reaction mixture was then added to excessive ethanol so that a polymer precipitate was produced. The precipitate was purified to obtain a polymer (P-1) which was then dried at 65° C. in vacuo for 24 hours.

### Example 1

The following components were charged into a mixing tank where they were then stirred to make a solution which was then filtered through a filter paper having an average pore diameter of 34 μm and a sintered metal filter having an average pore diameter of 10 μm.

Cyclic polyolefin solution D-1

| | |
|---|---|
| Cyclic polyolefin P-1 | 150 parts by mass |
| Dichloromethane | 380 parts by mass |
| Methanol | 70 parts by mass |

Subsequently, the following components, including the cyclic polyolefin solution thus prepared, were charged into a dispersing machine to prepare a fine particles dispersion.

Fine particles dispersion M-1

| | |
|---|---|
| Silica particles having a primary average particle | 7 parts by mass |
| diameter of 16 nm (Aerosil R972, produced by | |
| NIPPON AEROSIL CO., LTD.) | |
| Dichloromethane | 73 parts by mass |
| Methanol | 10 parts by mass |
| Cyclic polyolefin solution D-1 | 10 parts by mass |

### [Preparation of Thermoplastic Film (TP-1)]

100 parts by mass of an acrylic acid ester copolymer having a weight-average molecular weight of 1,200,000 (consisting of 97% by mass of a butyl acrylate unit and 3% by mass of an acrylic acid unit), 0.05 parts by mass of trimethylolpropane (modified) tolylenediisocyanate as a crosslinking agent and 0.1 parts by mass of 2,6-di-t-butyl-p-cresol, which is a phenolic oxidation inhibitor, as a radical scavenger were added to 200 parts by mass of toluene to prepare an adhesive solution. Subsequently, the adhesive solution thus prepared was spread over a release material comprising a polyethylene terephthalate film having a thickness of 38 μm coated with a silicone resin on one side thereof [trade name: SP PET38, produced by Lintec Corporation] on the silicone resin-coated surface thereof. The coated material was then dried at 100° C. for 1 minute to prepare a thermoplastic film (TP-1) having a 30 μm thick adhesive layer.

100 parts by mass of the aforementioned cyclic polyolefin solution (D-1) and 1.35 parts by mass of the aforementioned fine particles dispersion (M-1) were each filtered, and then mixed. The mixture was then cast using a band casting machine. When the residual solvent content reached 50% by mass, the film was then peeled off the band. The film was then crosswise stretched by a factor of 9% using a tenter. The film thus stretched was then dried at 140° C. for 15 minutes. Subsequently, TP-1 was continuously stuck to the film to prepare a cyclic polyolefin film laminate (101-1). The resulting cyclic polyolefin film had a residual solvent content of less than 0.1% by mass and a thickness of 80 μm. The properties of the film thus prepared are set forth in Table 1 below. In Table 1, the column of cyclic polyolefin gives the name of the cyclic polyolefin material used, the column of friction coefficient and handleability of laminate give the physical properties of the cyclic polyolefin film laminate, and the column of optical properties gives the physical properties of the cyclic polyolefin film excluding the thermoplastic film. Referring to the optical unevenness, the sample was disposed interposed between the polarizing plates disposed in crossed Nicols. The laminate was then visually evaluated. For the handleability of the film, the film was relatively evaluated for wrinkles in the interior thereof and susceptibility to buckling or the like.

### Comparative Example 1

A cyclic polyolefin film (101-2) was prepared in the same manner as in Example 1 except that TP-1 was not stuck to the film. The cyclic polyolefin film (101-2) thus obtained had a residual solvent content of less than 0.1% by mass and a thickness of 80 μm.

### Example 2

A cyclic polyolefin film (102-1) was prepared in the same manner as in Example 1 except that the fine particles dispersion M-1 was not added. The cyclic polyolefin film (102-1) thus obtained had a residual solvent content of less than 0.1% by mass and a thickness of 80 μm.

### Comparative Example 2

A cyclic polyolefin film (102-2) was prepared in the same manner as in Comparative Example 1 except that the fine particles dispersion M-1 was not added. The cyclic polyolefin film (102-2) thus obtained had a residual solvent content of less than 0.1% by mass and a thickness of 80 μm.

### Example 3-4; Comparative Example 3-4

Film materials were prepared in the same manner as Examples 1 and 2 except that the cyclic polyolefin P-1 was replaced by Appear 3000 (produced by Ferrania Inc.).

### Example 5

The following components were charged into a mixing tank where they were then stirred to make a solution which was then filtered through a filter paper having an average pore diameter of 34 μm and a sintered metal filter having an average pore diameter of 10 μm.

Cyclic polyolefin solution D-2

| | |
|---|---|
| Cyclic polyolefin: Zeonor ZF-14 | 100 parts by mass |
| Paraffin wax 135 (NIPPON SEIRO CO., LTD) | 10 parts by mass |
| Cyclohexanone | 450 parts by mass |

Subsequently, the following components, including the cyclic polyolefin solution thus prepared, were charged into a dispersing machine to prepare a fine particles dispersion.

Fine particles dispersion M-2

| | |
|---|---|
| Silica particles having a primary average particle | 2 parts by mass |
| diameter of 16 nm (Aerosil R972, produced by | |
| NIPPON AEROSEL CO., LTD.) | |
| Cyclohexanone | 83 parts by mass |
| Cyclic polyolefin solution D-2 | 10 parts by mass |

### [Preparation of Thermoplastic Film (TP-2)]

A water-alcohol solution of a 100:47 (by weight ratio in terms of solid content) mixture of an antistatic inhibitor made of a cationic polymer (main agent of “Bondip P”, produced by Konishi Co., Ltd.) and an epoxy resin hardener (hardener of “Bondip P”, produced by Konishi Co., Ltd.) was spread over one side of a biaxially-stretched polyethylene terephthalate film having a thickness of 25 μm, and then dried to form an antistatic layer at a spread of 0.2 g/m² as calculated in terms of dried amount. Subsequently, a solution obtained by diluting a 100:3 (by weight ratio in terms of solid content) mixture of an aminoalkyd resin (“TA31-209E”, produced by Hitachi Chemical Co., Ltd.) and an acidic catalyst (“Dryer 900”, produced by Hitachi Chemical Co., Ltd.) with a solvent was spread over the antistatic layer, and then dried to form a stainproof layer having a spread of 0.2 g/m² as calculated in terms of dried amount. Subsequently, a solution of an acrylic solvent type adhesive made of a 2-ethylhexyl acrylate-butyl acrylate-vinyl acetate copolymer was spread over the other side of the biaxially-stretched polyethylene terephthalate film, and then dried to form a slightly adhesive layer having a spread of 25 g/m².

100 parts by mass of the aforementioned cyclic polyolefin solution (D-2) and 1.35 parts by mass of the fine particles dispersion (M-2) were each filtered, and then mixed. The mixture was then cast using a band casting machine. When the residual solvent content reached 40% by mass, the film was then peeled off the band. The film was then dried at 140° C. for 15 minutes. Subsequently, TP-2 was continuously stuck to the film to prepare a cyclic polyolefin film laminate (105-1).

The resulting cyclic polyolefin film had a residual solvent content of less than 0.1% by mass and a thickness of 80 μm. The properties of the film thus prepared are set forth in Table 1 below.

### Comparative Example 5

A cyclic polyolefin (105-2) was prepared in the same manner as in Example 5 except that TP-2 was not stuck to the film. The resulting cyclic polyolefin film (105-2) had a residual solvent content of less than 0.1% by mass and a thickness of 80 μm.

### Example 6

### Preparation of Polarizing Plate

The cyclic polyolefin film laminate of the invention was then evaluated for properties as a protective film for polarizing plate. A rolled polyvinyl alcohol film having a thickness of 80 μm was continuously stretched by a factor of 5 in an aqueous solution of iodine, and then dried to obtain a polarizing film having a thickness of 20 μm. Subsequently, The polarizing film thus obtained was disposed interposed between the saponified film samples (101-1) and (104-1), and then stuck to the films with a 3 mass-% aqueous solution of a polyvinyl alcohol “PVA-117H” {produced by KURARAY CO., LTD.} to obtain a polarizing plate (P1-1) protected by a film sample on the both sides thereof. In this arrangement, sticking was effected such that the cyclic polyolefin surface of the film sample on the both sides of the polarizing film were each opposed to the polarizing film and the slow axis was parallel to the transmission axis of the polarizing film. In the polarizing plate (P1-1), the two sheets of film sample and the polarizing film kept a sufficient sticking adhesion to each other and showed sufficient polarization.

TABLE 1

| | | | | | Static friction | | | | |
|---|---|---|---|---|---|---|---|---|---|
| | Sample | Cyclic | Fine | Thermoplastic | coefficient of | Optical properties | | Optical | |
| No. | No. | polyolefin | particle | film | laminate | Re(nm) | Rth(nm) | unevenness | Handleability |
| Example 1 | 101-1 | P-1 | M-1 | TP-1 | 0.68 | 40 ± 1 | 220 ± 4 | A | A |
| Comparative | 101-2 | P-1 | M-1 | None | 0.85 | 39 ± 3 | 215 ± 8 | B | B-C |
| Example 1 | | | | | | | | | |
| Example 2 | 102-1 | P-1 | None | TP-1 | 0.75 | 36 ± 2 | 218 ± 5 | A | A |
| Comparative | 102-2 | P-1 | None | None | Immeasurable | 35 ± 4 | 217 ± 10 | C | C |
| Example 2 | | | | | | | | | |
| Example 3 | 103-1 | Appear | M-1 | TP-1 | 0.43 | 28 ± 2 | 205 ± 5 | A | A |
| | | 3000 | | | | | | | |
| Comparative | 103-2 | Appear | M-1 | None | 0.81 | 28 ± 4 | 200 ± 8 | B-C | B |
| Example 3 | | 3000 | | | | | | | |
| Example 4 | 104-1 | Appear | None | TP-1 | 0.63 | 28 ± 3 | 198 ± 5 | A | A |
| | | 3000 | | | | | | | |
| Comparative | 104-2 | Appear | None | None | 1.35 | 28 ± 6 | 202 ± 12 | C | C |
| Example 4 | | 3000 | | | | | | | |
| Example 5 | 105-1 | Zeonor | M-2 | TP-2 | 0.63 | 5 ± 0.5 | 8 ± 0.5 | A | A |
| | | ZF-14 | | | | | | | |
| Comparative | 105-2 | Zeonor | M-2 | None | 0.81 | 4 ± 1.0 | 9 ± 1.5 | B | B-C |
| Example 5 | | ZF-14 | | | | | | | |
| Example 6 | 106-1 | Zeonor | None | TP-2 | 0.71 | 6 ± 0.5 | 10 ± 0.5 | A | A |
| | | ZF-14 | | | | | | | |
| Comparative | 106-2 | Zeonor | None | None | Immeasurable | 6 ± 1.5 | 8 ± 1.5 | C | C |
| Example 6 | | ZF-14 | | | | | | | |

For the measurement of Re retardation and Rth retardation, sampling was made on the film sample over a 1,460 mm width at an interval of 20 cm. The difference between maximum value and minimum value of these properties was then determined.

Evaluation of optical unevenness: A: No unevenness observed; B: Some unevenness observed but practically tolerated; C: Not practically tolerated
Evaluation of handleability: A: No backlash observed and windable; B: Some backlash generated, but no wrinkles generated; C: Wrinkles generated

### INDUSTRIAL APPLICABILITY

In accordance with the invention, there can be provided a cyclic polyolefin film which exhibits excellent moisture absorption and moisture permeability, undergoes little change of optical properties with temperature and humidity and shows no optical unevenness. Further, the use of a cyclic polyolefin film according to the invention excellent in film forming stability and processability makes it possible to provide a polarizing plate or a liquid crystal display having no image unevenness.

The entire disclosure of each and every foreign patent application from which the benefit of foreign priority has been claimed in the present application is incorporated herein by reference, as if fully set forth.

1. A film laminate comprising:
a cyclic polyolefin film containing a cyclic polyolefin-based resin; and
a thermoplastic film containing a thermoplastic resin,
wherein a static friction coefficient between one surface of the film laminate and the other surface of the film laminate is from 0.2 to 0.8

2. The film laminate according to claim 1,
wherein the thermoplastic resin comprises a polyethylene terephthalate, polyethylene or polypropylene.

3. The film laminate according to claim 1,
wherein the cyclic polyolefin film has a thickness of from 10 μm to 120 μm.

4. The film laminate according to claim 1,
wherein the cyclic polyolefin film further contains fine particles having a primary average particle diameter of from 1 nm to 20,000 nm in an amount of from 0.01 to 0.3 parts by mass based on 100 parts by mass of the cyclic polyolefin-based resin.

5. The film laminate according to claim 4,
wherein the fine particles are fine particles of a metal oxide or fine particles of inorganic silicon compound, each of which have a primary average particle diameter of from 2 nm to 1,000 nm.

6. A production method of the film laminate according to claim 1, which comprises:
a step of dissolving the cyclic polyolefin-based resin in a solvent so as to form a dope;
a step of casting the dope so as to form the cyclic polyolefin film;
a step of drying the cyclic polyolefin film; and
a step of sticking the cyclic polyolefin film to the thermoplastic film at any step after the step of casting.

7. The production method of the film laminate according to claim 6, which further comprises:
a step of stretching the cyclic polyolefin film after the step of casting.

8. An optically-compensatory film comprising:
the film laminate according to claim 1; and
an optically anisotropic layer which is stuck to the film laminate and has Re₆₃₀ of from 0 nm to 200 nm and |Rth₆₃₀| of from 0 nm to 400 nm,
wherein Re₆₃₀ represents an in-plane retardation value of the optically anisotropic layer at a wavelength of 620 nm; and
Rth₆₃₀ represents a thickness-direction retardation value of the optically anisotropic layer at a wavelength of 620 nm.

9. A polarizing plate comprising the film laminate according to claim 1 as a protective film for polarizing film.

10. A liquid crystal display comprising the polarizing plate according to claim 9.
